(19) United States
(12) Patent Application Publication
(10) Pub. No.: US 2008/0063336 A1
(43) Pub. Date: Mar. 13, 2008

(54) Mounting structure for engagement of sleeves

(76) Inventor: William Chuang, Shulin City (TW)

Correspondence Address: BACON & THOMAS, PLLC, 625 SLATERS LANE, FOURTH FLOOR, ALEXANDRIA, VA, 22314, US

(21) Appl. No.: 11/517,350

(22) Filed: Sep. 8, 2006

(51) Int. Cl. F16C 13/00

(52) U.S. Cl. 384/546

(57) ABSTRACT

A mounting structure for engagement of sleeves has an outer sleeve and an inner sleeve. The outer sleeve is mounted around the inner sleeve and has an outer surface. The inner sleeve has an isolating slot and may have at least one functionary element. The isolating slot is defined in the inner sleeve between the inner surface and the outer surface of the outer sleeves and has a depth. When an appropriate force is applied to the outer surface of the outer sleeve to make the sleeves deform to engage with each other, the deformation of the inner sleeve will stop by the isolating sleeve. Therefore the functionary elements mounted inside the inner sleeve will not be damaged.

### BACKGROUND OF THE INVENTION

1. Field of the Invention

The present invention relates to a mounting structure, and more particularly to a mounting structure for engagement of sleeves to isolate deformation when the sleeves engage with each other.

2. Description of Related Art

Many mounting methods have been developed and are used to mechanically connect components such as sleeves. The typical mounting methods such as riveting, compression fitting and the like are generally pressing or squeezing said sleeves to deform said sleeves and to generate internal force that make said sleeves bond or connect together.

However, significant deformation of the sleeves by enough pressing or squeezing force to effectively connect the sleeves may probably damage functional elements mounted inside the sleeves.

To overcome the shortcomings, the present invention provides a mounting structure for engagement of sleeves to obviate or mitigate the aforementioned problems.

### SUMMARY OF THE INVENTION

The main objective of the present invention is to provide a mounting structure for engagement of sleeves that avoid damaging functionary elements mounted inside the sleeves when force is applied to the sleeve for engagement.

In order to achieve the objective mentioned above, the mounting structure for engagement of sleeves in accordance with the present invention comprises an outer sleeve and an inner sleeve. The outer sleeve is mounted around the inner sleeve and has an outer surface. The inner sleeve has an inner surface, an isolating slot and may have at least one functionary element. The isolating slot is defined in the inner sleeve and has a depth. The at least one functionary element is mounted inside the inner sleeve adjacent to the inner surface.

With such an arrangement, when an appropriate force is applied to the outer surface of the outer sleeve to make the inner sleeve and the outer sleeve deform to engage with each other, the deformation of the inner sleeve will be stopped by the isolating slot. Consequently, the inner surface of the inner sleeve will not be deformed and the functionary elements mounted inside the inner sleeve are not damaged.

Additionally, with the defining of the isolating slot, the thickness of the inner sleeve is reduced, so that the force need to be applied for deforming the inner sleeve for engagement is decreased.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of the mounting structure for engagement of sleeves in accordance with the present invention; and

FIG. 2 is an operational side view in partial section of the mounting structure in FIG. 1, showing the inner sleeve and the outer sleeve are deforming when an appropriate force is applied to the mounting portion of the inner sleeve and the distal end of the outer sleeve.

### DETAILED DESCRIPTION OF THE PREFERRED EMBODIMENT

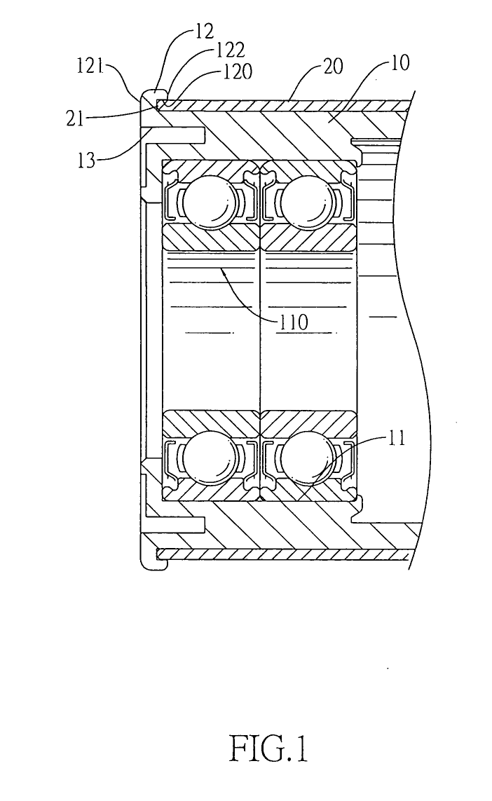

With reference to FIG. 1, the mounting structure for engagement of sleeves in accordance with the present invention comprises an inner sleeve (10) and an outer sleeve (20).

The inner sleeve (10) has a mounting end, a chamber (11), a mounting portion (12), an isolating slot (13) and may have multiple functionary elements (110).

The mounting end has a center and an outer edge. The chamber (11) is defined inside the inner sleeve (10) and has an inner surface. The mounting portion (12) is formed on the mounting end of the inner sleeve (10) along the outer edge of the mounting end and has a distal side (121), a proximal side (122) and a notch (120). The notch (120) is defined in the proximal side (122) of the mounting portion (12). The isolating slot (13) is annular and defined in the mounting end of the inner sleeve (10) near the outer edge of the mounting end and has a determined depth. The functionary elements (110) are mounted inside the chamber (11), adjacent to the inner surface of the chamber (11) and may be bearings.

The outer sleeve (20) is mounting around the inner sleeve (10) and has an outer surface and a distal end (21) mounted in the notch (120) of the mounting portion (12).

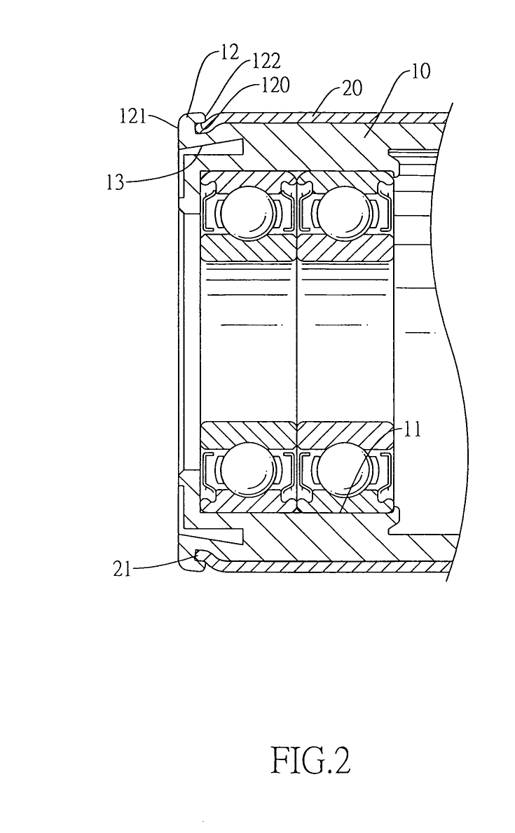

With reference to FIG. 2, when an appropriate force is applied to the mounting portion (12) of the inner sleeve (10) and the distal end (21) of the outer sleeve (20), the mounting portion (12) and the distal end (21) of the outer sleeve (20) have a deformation and eventually be mounted securely together. Because of the isolating slot (13), the deformations of the mounting portion (12) and the will not deform the chamber (11) of the inner sleeve (10). Consequently, the inner surface of the inner sleeve (10) will not deform simultaneously and the functionary elements (110) mounted inside the chamber (11) may not being damaged.

Additionally, with the defining of the isolating slot (13), the thickness of the inner sleeve (10) is reduced, so that the force need to be applied for deforming the inner sleeve (10) for engagement is decreased.

What is claimed is:

1. A mounting structure for engagement of sleeves comprising
an inner sleeve having
a mounting end having
a center; and
an outer edge;
a chamber being defined inside the inner sleeve and having an inner surface; and
an isolating slot being annular and defined in the mounting end of the inner sleeve near the outer edge of the mounting end and having a depth; and
an outer sleeve being mounting around the inner sleeve and having an outer surface.

2. The mounting structure as claimed in claim 1, wherein
the inner sleeve further has a mounting portion being formed on the mounting end of the inner sleeve along the outer edge of the mounting end and having
a distal side;
a proximal side; and
a notch defined in the proximal side of the mounting portion; and
the outer sleeve has a distal end mounted in the notch of the mounting portion.

3. The mounting structure as claimed in claim 2, wherein the inner sleeve further has at least one functionary element being mounted inside the chamber adjacent to the inner surface of the chamber.

4. The mounting structure as claimed in claim 3, wherein each one of the at least one functionary element is a bearing.
